(19) United States
(12) Patent Application Publication
(10) Pub. No.: US 2014/0186570 A1
(43) Pub. Date: Jul. 3, 2014

(54) METHOD FOR STRENGTHENING GLASS SUBSTRATE AND ARTICLE MANUFACTURED BY THE SAME

(71) Applicants: FIH (Hong Kong) Limited, Kowloon (HK); SHENZHEN FUTAIHONG PRECISION INDUSTRY CO., LTD., Shenzhen (CN)

(72) Inventor: REN-BO WANG, Shenzhen (CN)

(21) Appl. No.: 13/928,519

(22) Filed: Jun. 27, 2013

(30) Foreign Application Priority Data
Dec. 28, 2012 (CN) 2012105820648

(51) Int. Cl. C03C 21/00; C03C 17/25

(52) U.S. Cl. CPC C03C 21/002; C03C 17/256
USPC 428/63; 428/410; 428/335; 428/337; 65/30.14

(57) ABSTRACT

A method for strengthening glass substrate includes: preheating a glass substrate; spraying a molted salt onto the substrate to form a ion exchange layer; forming a titanium dioxide layer on the ion exchange layer. The ion exchange layer infills some microcracks. The titanium dioxide layer reinforces the infilling of microcracks and applying further toughness. An article manufactured by the method is also provided.

### BACKGROUND

1. Technical Field

The present disclosure relates to a method for strengthening glass substrate and articles manufactured by the method.

2. Description of Related Art

Glass substrates may be used as cover sheets and/or touch screens for LCD and LED displays incorporated in mobile telephones, GPS devices, display devices such as televisions and computer monitors and other electronic devices. However, the toughness of the basic glass substrate is low and the substrate is susceptible to damage.

To enhance the toughness, a chemical strengthening process is widely used to treat glass substrates. Traditionally, the chemical strengthening process is carried out by dipping the glass substrate in a molten salt solution containing potassium ions, which forms an ion exchange layer having a thickness of about 8 μm to about 12 μm in the glass substrate. However, when the thickness of the glass substrate is thicker than 1.5 mm, the ion exchange layer cannot completely fill in all the micro cracks on the outer surface of glass substrate. Additionally, during the chemical strengthening process, the corners of the glass substrate have fewer potassium ions aggregated thereon compared to the expanse of the glass substrate. Consequently, the corners of the glass substrate do not have the same strengthening effect as the rest of the substrate.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a cross-sectional view of an exemplary embodiment of an article.

FIG. 2 is a schematic view of an exemplary embodiment of a strengthening treatment device.

### DETAILED DESCRIPTION

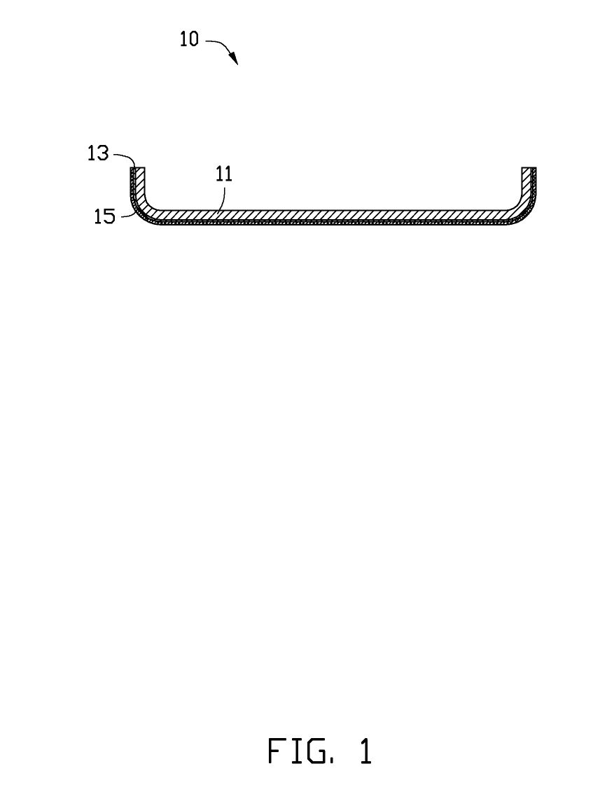

Referring to FIG. 1, an exemplary method for strengthening glass substrate may include at least the following steps:

(1) A glass substrate 11 is provided.

The glass substrate 11 is a sodium silicate glass substrate. The thickness of the glass substrate 11 is about 0.5 mm to about 3 mm. The glass substrate may have a plurality of micro cracks (not shown) defined on the surface of the glass substrate 11 caused by the annealing process during the manufacturing of the glass substrate or other causes. The glass substrate 11 may be a plain glass or a glass having a three-dimensional structure.

In the embodiment, the glass substrate 11 having a three-dimensional structure is made from a plain glass by hot bending treatment.

(2) The glass substrate 11 is polished to smoothen the inside and outside surfaces of the glass substrate 11.

(3) The glass substrate 11 is strengthened to form an ion exchange layer 13.

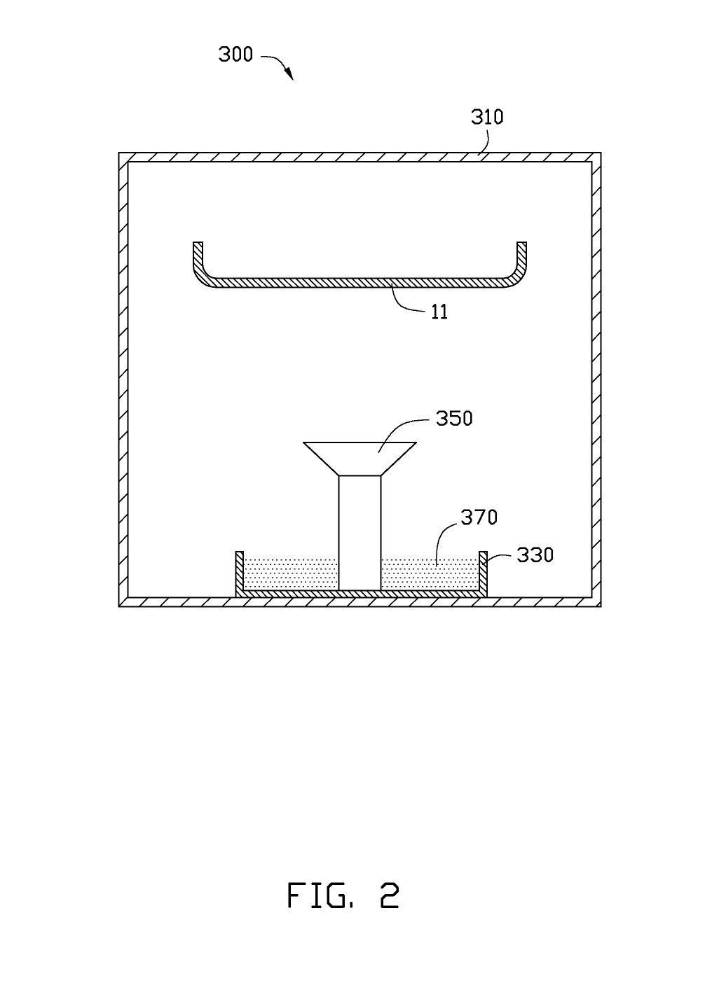

Referring to FIG. 2, a strengthening treatment device 300 is provided. The device 300 includes a strengthening furnace 310, a bath 330 retained in the furnace 310, and a horn-shaped spraying element 350 inserted into the bath 330. The bath 330 contains salt solution 370.

The strengthening process is carried out by the following steps: firstly, the glass substrate 11 is placed in the device 300 above the spraying element 350, and the internal temperature of the furnace 310 is heated to about 200° C.-450° C. at a rate of about 2° C./min-12° C./min to pre-heat the glass substrate 11; secondly, the internal temperature of the furnace 310 and the salt solution 370 is heated to about 450° C.-550° C. at a rate of about 5° C./min-10° C./min, thus melting the salt solution 370; thirdly, the melted salt solution 370 is sprayed on the glass substrate 11 for about 90 min-240 min by the spraying element 350, which facilitates an ion exchange between potassium ions included in the glass substrate 11 and potassium ions included in the salt solution 370; fourthly, the internal temperature of the furnace 310 is decreased to room temperature at a rate of about 1° C./min-2° C./min.

In the embodiment, the salt solution 370 contains potassium nitrate, auxiliary substances (see below for description) and water, wherein the mass percentage of the potassium nitrate is about 54% to about 72%, the mass percentage of the auxiliary substances is about 4% to about 10%, the mass percentage of water is about 2.3% to about 7.5%. The auxiliary substances include corundum powder, potassium silicate and diatomite, wherein the mass percentage of the corundum powder is about 25% to about 35%, the mass percentage of the potassium silicate is about 25% to about 40%, and the mass percentage of diatomite is about 25% to about 50%.

During the strengthening process, sodium ions from the glass substrate 11 are exchanged with potassium ions included in the salt solution 370 to form an ion exchange layer 13. Some of the micro cracks are filled and smoothed over by potassium ions, because the diameter of each potassium ion is larger than the diameter of the sodium ion. The ion exchange layer 13 has a thickness of about 10 μm to about 30 μm.

During the strengthening process, melted salt solution 370 is sprayed evenly on the surface of the glass substrate 11, which makes the glass substrate 11 have a three-dimensional structure that is uniform in strength. Additionally, less of the salt solution 370 is consumed by the method compared to the consumption in the traditional chemical strengthening process.

(4) A titanium dioxide layer 15 is formed on the ion exchange layer 13 by thermal spraying.

A spraying solution is provided. The spraying solution includes carbon tetrachloride and organic solution, wherein the mass percentage of the carbon tetrachloride is about 58% to about 80%, and the mass percentage of the organic solution is about 20% to about 42%. The organic solution is an alcohol, such as ethanol or methanol.

The glass substrate 11 is positioned in a sealed chamber (not shown). The internal temperature of the chamber is heated to about 500° C.-700° C. The spraying solution is sprayed on the ion exchange layer 13. Meanwhile, the carbon tetrachloride decomposes into titanium dioxide as a result of the high internal temperature of the chamber (500° C.-700° C)., which forms a titanium dioxide layer 15 on the ion exchange layer 13. The titanium dioxide layer 15 consists of titanium dioxide. The thickness of the titanium dioxide layer 15 is about 15 μm-30 μm.

The titanium dioxide layer 15 is formed on the ion exchange layer 13. Some of the titanium dioxide included in the titanium dioxide layer 15 is embedded in the micro cracks which are left unfilled by the potassium ions.

The above method not only strengthens the glass substrate 11 having a thickness less than 1.5 mm, but also strengthens the glass substrate 11 having a thickness about 1.5 mm to about 3 mm.

An article 10 manufactured by the above method is also provided. The article 10 includes a glass substrate 11, an ion exchange layer 13 formed on the glass substrate 11, and a titanium dioxide layer 15 formed on the ion exchange layer 13.

The glass substrate 11 defines a plurality of micro cracks. The thickness of the glass substrate 11 is about 0.5 mm to about 3 mm.

The ion exchange layer 13 has sodium ions and potassium ions. Potassium ions are embedded in the glass substrate, partly filling any micro cracks. The ion exchange layer 13 has a thickness of about 10 μm to about 30 μm.

The titanium dioxide layer 15 is formed on the ion exchange layer 13. Some of titanium dioxide included in the titanium dioxide layer 15 embeds in the micro cracks which are left unfilled by potassium ions. The titanium dioxide layer 15 consists of titanium dioxide. The thickness of the titanium dioxide layer 15 is about 15 μm-30 μm.

The ion exchanging layer 13 and the titanium oxide layer 15 are resistant to the propagation of existing micro cracks and the formation of new micro cracks due to impacts, thus improving the strength and toughness of the glass substrate 11. Additionally, the titanium oxide layer 15 provides an enhanced resistance to abrasions and scratches.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A method for strengthening a glass substrate comprising:
providing a glass substrate and a salt solution;
spraying the salt solution on the glass substrate to form an ion exchange layer on the glass substrate.

2. The method of claim 1, wherein the thickness of the glass substrate is about 0.5 mm to about 3 mm.

3. The method of claim 2, wherein the thickness of the glass substrate is about 1.5 mm to about 3 mm.

4. The method of claim 1, wherein the glass substrate is a sodium silicate glass substrate.

5. The method of claim 1, wherein the ion exchange layer is formed by the following:
retaining the glass substrate in a strengthening furnace; heating the furnace to about 200° C.-450 ° C. at a rate of about 2° C./min-12° C./min to pre-heat the glass substrate; heating the internal temperature of the furnace and the salt solution to about 450° C.-550° C. at a rate of about 5/min-10° C/min to melt the salt solution; spraying the melted salt solution on the glass substrate for about 90 min-240 min; and decreasing the internal temperature of the furnace to room temperature at a rate of about 1° C./min-2° C./min.

6. The method of claim 1, wherein the salt solution comprises potassium nitrate and water.

7. The method of claim 6, wherein in the salt solution, the mass percentage of the potassium nitrate is about 54% to about 72%, and the mass percentage of water is about 2.3% to about 7.5%.

8. The method of claim 6, wherein the salt solution further comprises auxiliary substances, the auxiliary substances include corundum powder, potassium silicate and diatomite.

9. The method of claim 6, wherein in the salt solution, the mass percentage of the auxiliaries is about 4% to about 10%.

10. The method of claim 6, wherein in the auxiliaries, the mass percentage of the corundum powder is about 25% to about 35%, the mass percentage of the potassium silicate is about 25% to about 40%, the mass percentage of diatomite is about 25% to about 50%.

11. The method of claim 1, further comprising spraying a spraying solution on the ion exchange layer by thermal spraying to form a titanium dioxide layer on the ion exchange layer, the spraying solution comprises carbon tetrachloride and organic solution.

12. The method of claim 11, wherein in the spraying solution, the mass percentage of the carbon tetrachloride is about 58% to about 80%, the mass percentage of the organic solution is about 20% to about 42%.

13. The method of claim 12, wherein the organic solution is ethanol and/or methanol.

14. The method of claim 12, wherein the titanium dioxide layer is formed by the following: positioning the glass substrate in a sealed chamber, the internal temperature of the chamber is heated to about 500° C.-700° C.; and spraying the spraying solution on the ion exchange layer, meanwhile the carbon tetrachloride is decomposed into titanium dioxide to form the titanium dioxide layer on the ion exchange layer.

15. A article comprising:
a glass substrate;
an ion exchange layer formed on the glass substrate, the ion exchange layer comprising sodium ion and potassium ion; and
a titanium dioxide layer formed on the ion exchange layer, the titanium dioxide layer consisting of titanium dioxide.

16. The article of claim 15, wherein the glass substrate has a plurality of micro cracks, potassium ions embeds in the glass substrate to fill the micro cracks.

17. The article of claim 16, wherein some of titanium dioxide included in the titanium dioxide layer embeds in the micro cracks which are left unfilled by potassium ions.

18. The article of claim 15, wherein the ion exchange layer has a thickness of about 10 μm to about 30 μm.

19. The article of claim 15, wherein the thickness of the titanium dioxide layer is about 15 μm-30 μm.

20. The article of claim 14, wherein the thickness of the glass substrate is about 0.5 mm to about 3 mm.
